(19) United States
(12) Patent Application Publication
(10) Pub. No.: US 2012/0162529 A1
(43) Pub. Date: Jun. 28, 2012

(54) AUTOMATIC VIDEO GAIN ADJUSTMENT METHOD

(75) Inventors: Chih-Chun Ho, New Taipei City (TW); Chih-Yuan Ho, New Taipei City (TW)

(73) Assignee: ABA ELECTRONICS TECHNOLOGY CO., LTD., New Taipei City (TW)

(21) Appl. No.: 13/101,352

(22) Filed: May 5, 2011

(30) Foreign Application Priority Data
Dec. 28, 2010 (TW) 099146277

(51) Int. Cl. H04N 5/52

(52) U.S. Cl. 348/678; 348/E05.115

(57) ABSTRACT

An automatic video gain adjustment method in which an automatic gain equalizer is used. The method includes steps of: using a processor to read and analyze a video signal and compare the video signal with a standard value to judge whether the video signal matches the standard value; using a gain regulator to automatically adjust the amplitude of the video signal in case the video signal fails to match the standard value, the gain regulator then generating an adjusted video signal; and using the processor to receive the adjusted video signal and transmit the adjusted video signal to a remote-end receiving device. By means of the automatic video gain adjustment method, the video signal can be automatically and more conveniently adjusted to match the standard value.

This application claims the priority benefit of Taiwan patent application number 099146277 filed on Dec. 28, 2010.

### FIELD OF THE INVENTION

The present invention relates to an automatic video gain adjustment method. By means of this method, the video signals received by a remote-end receiving device can be automatically and conveniently adjusted to reach a standard value.

### BACKGROUND OF THE INVENTION

In a public site such as a school, a remote-end receiving device such as a television or a projector is connected to an electronic device at the other end, (such as a DVD player, a computer and a notebook), via a signal transmission cable. The video signals output from the electronic device are transmitted to the remote-end receiving device via the signal transmission cable for the remote-end receiving device to play the received video signals.

However, a common signal transmission cable is evermore exposed to exterior side and subject to affection of environmental factors such as humidity, weather and aging of the cable material. As a result, the video signals are likely to be distorted. Moreover, the length of the signal transmission cable is limited to several meters. In the case that the length of the signal transmission cable exceeds the range, the video signals will attenuate to lead to distortion of the video signals. This is illustrated with an example as follows: In the case that the distance between the remote-end receiving device and the electronic device exceeds the length range of the signal transmission cable, the video signals transmitted from the electronic device will attenuate and the amplitude of the video signals displayed on the remote-end receiving device will be reduced to result in darkening or distortion of the picture displayed on the remote-end receiving device.

To solve the above problem, a manual video gain adjustment method has been developed as shown in FIG. 1. A manual gain equalizer 10 is used in the manual video gain adjustment method. The manual gain equalizer 10 has a red color compensation button 101, a green color compensation button 102 and a blue color compensation button 103. The manual gain equalizer 10 is connected to a remote-end receiving device 12 and a transmitter 14. The transmitter 14 is connected to the manual gain equalizer 10 via a signal transmission cable A1 for transmitting video signals. The other end of the transmitter 14 is connected to an electronic device 16. The remote-end receiving device 12 is connected to the manual gain equalizer 10 via a VGA signal cable A2 for transmitting video signals. The transmitter 14 is connected to the electronic device 16 via another VGA signal cable A3 for transmitting video signals.

The electronic device 16 serves to transmit video signals to the transmitter 14. The transmitter 14 then transmits the video signals to the manual gain equalizer 10 via the signal transmission cable A1. The manual gain equalizer 10 serves to transmit the received video signals to the remote-end receiving device 12 to display. Then, a user 17 can use a tool 171 such as a screwdriver to rotate the red color adjustment button 101, the green color adjustment button 102 and the blue color adjustment button 103 of the manual gain equalizer 10 for adjusting the video signals.

According to the above method, the user 17 needs to continuously observe the remote-end receiving device 12 at the same time to see whether the video signals displayed on the remote-end receiving device 12 match the original video signals transmitted from the electronic device 16. If the video signals displayed on the remote-end receiving device 12 match the original video signals, the user 17 stops rotating the compensation buttons. On the contrary, if the video signals displayed on the remote-end receiving device 12 fail to match the original video signals, the user 17 needs to continuously observe the remote-end receiving device 12 and repeatedly rotate the respective compensation buttons to adjust the video signals until the video signals displayed on the remote-end receiving device 12 match the original video signals transmitted from the electronic device 16.

By means of the conventional manual video gain adjustment method, the distortion of the video signals displayed on the remote-end receiving device 12 can be improved. However, the effect is limited. This is because when adjusting the compensation buttons of the manual gain equalizer 10, the displayed video signals are distinguished with human eyes. It is hard for a user to precisely adjust the video signals to a standard value. The standard value is a standard value of the amplitude of the video signal, which is 0.7 Vp-p volt. Therefore, by means of the conventional manual video gain adjustment method, it is hard to adjust the video signals to the standard value. Moreover, the adjustment process is quite troublesome and complicated.

According to the aforesaid, the conventional technique has the following shortcomings:

1. It is hard to precisely adjust the video signals to the standard value.

2. The adjustment process is quite troublesome and complicated.

3. It is inconvenient to perform the adjustment process.

### SUMMARY OF THE INVENTION

A primary object of the present invention is to provide an automatic video gain adjustment method. By means of this method, the video signals displayed on a remote-end receiving device can be automatically adjusted.

A further object of the present invention is to provide the above automatic video gain adjustment method. By means of this method, the adjustment process can be more conveniently performed.

A still further object of the present invention is to provide the above automatic video gain adjustment method. By means of this method, the adjustment process is simplified so that the adjustment time is shortened.

To achieve the above and other objects, the automatic video gain adjustment method is applied to an automatic gain equalizer. The method includes steps of: using a processor to read and analyze a video signal and compare the video signal with a standard value to judge whether the video signal matches the standard value; using a gain regulator to automatically adjust the amplitude of the video signal in case the video signal fails to match the standard value, the gain regulator then generating an adjusted video signal; and using the processor to receive the adjusted video signal and transmit the adjusted video signal to a remote-end receiving device. By means of the automatic video gain adjustment method, the video signal can be automatically and more conveniently adjusted to match the standard value.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view showing a conventional manual video gain adjustment method;

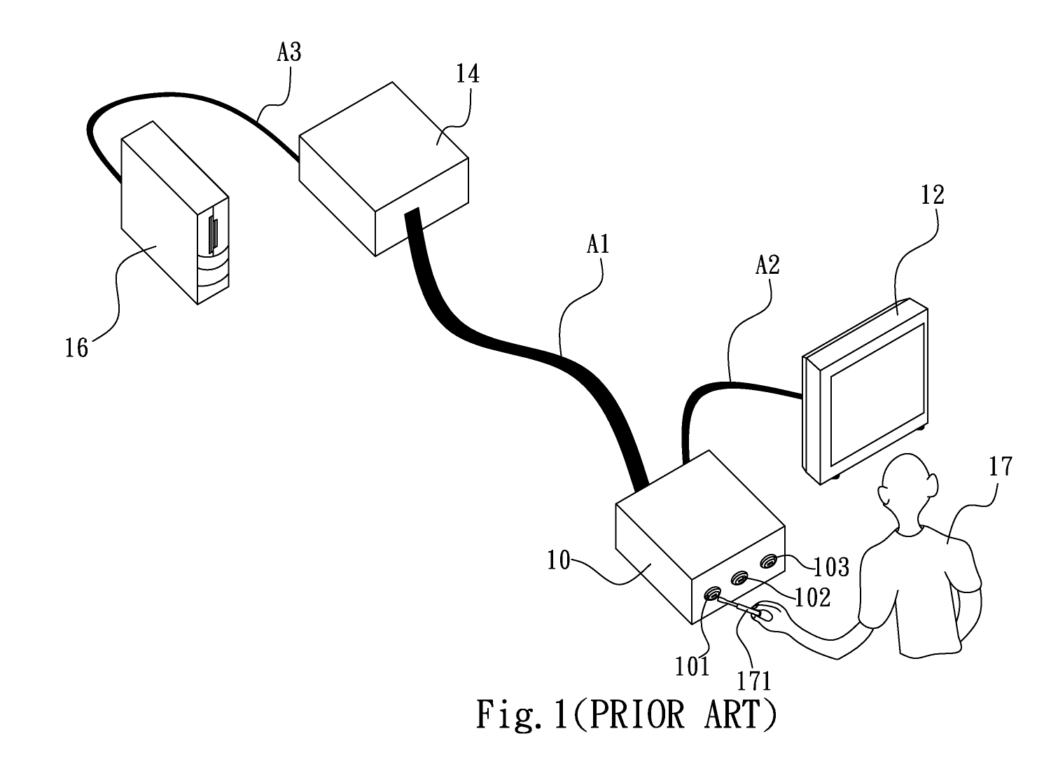

FIG. 2 is a perspective view showing a preferred embodiment of the automatic video gain adjustment method of the present invention;

FIG. 3 is a block diagram of the preferred embodiment of the automatic video gain adjustment method of the present invention; and

FIG. 4 is a flow chart of the preferred embodiment of the automatic video gain adjustment method of the present invention.

### DETAILED DESCRIPTION OF THE PREFERRED EMBODIMENTS

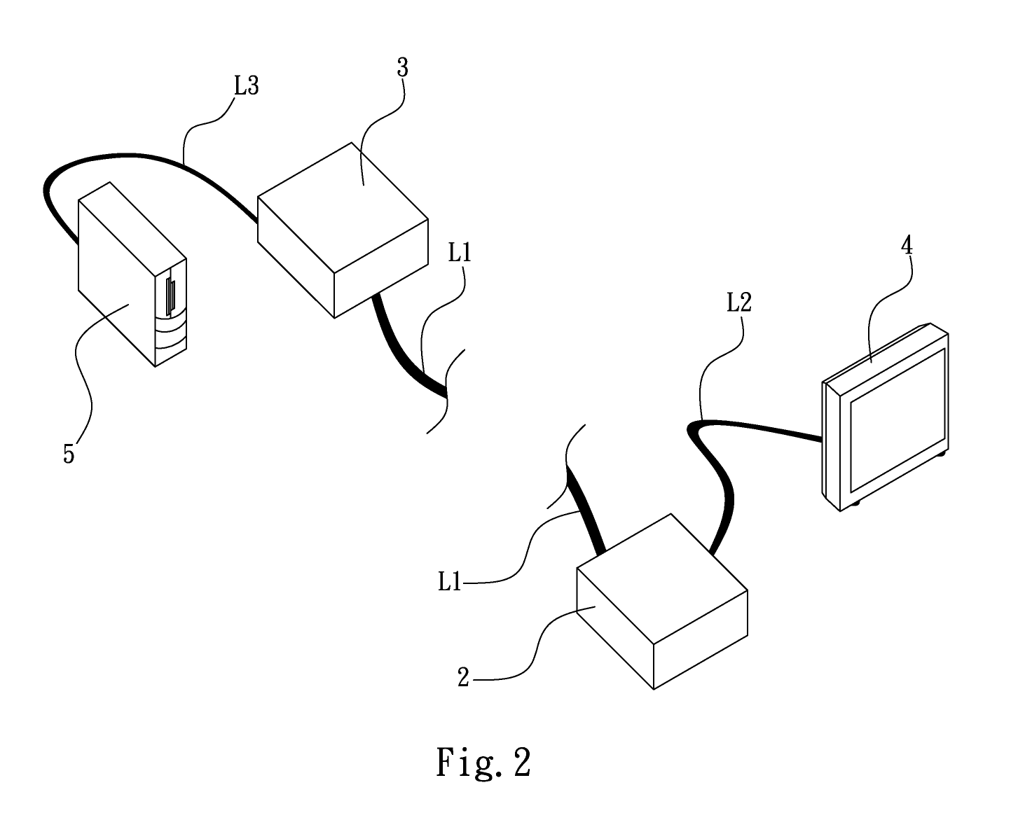

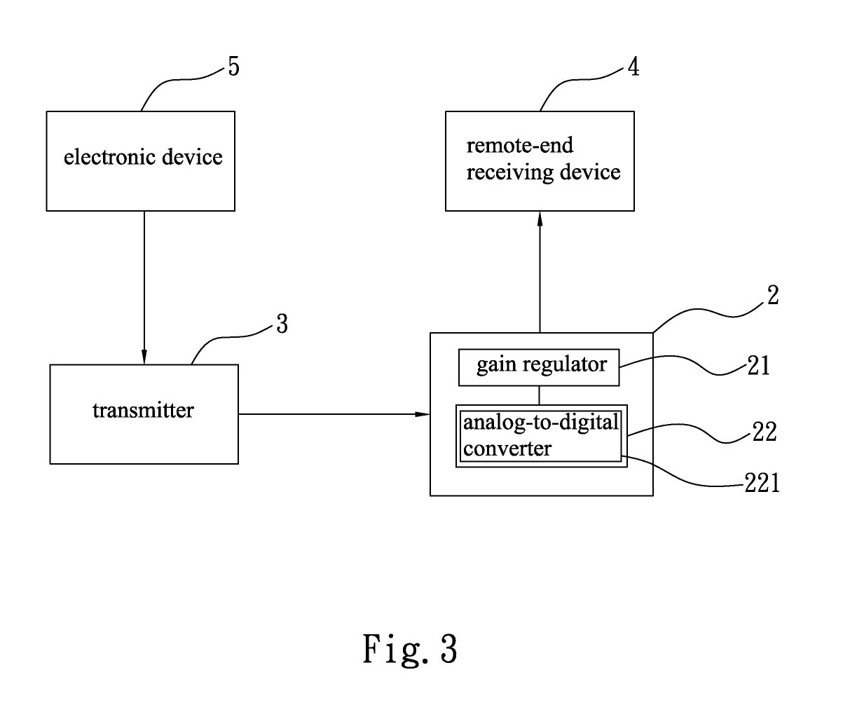

Please refer to FIGS. 2 and 3, which show a preferred embodiment of the automatic video gain adjustment method of the present invention. An automatic gain equalizer 2 is used in the method. The automatic gain equalizer 2 is connected to a transmitter 3 and co-used therewith. The transmitter 3 is connected with the automatic gain equalizer 2 via a first transmission cable L1 for transmitting signals. The first transmission cable L1 can be a CAT5 cable, a CAT5e cable or a CAT6 cable. In this embodiment, the first transmission cable L1 is a CAT5e cable for illustration purposes only.

One end of the transmitter 3 is connected to an electronic device 5, for example, a video player (such as a DVD player or a VCD player), a computer or a notebook via a third transmission cable L3. The other end of the transmitter 3 is connected with the first transmission cable L1. The transmitter 3 serves to receive a video signal transmitted from the electronic device 5 and transmits the video signal to the automatic gain equalizer 2 via the first transmission cable L1. After receiving the video signal, the automatic gain equalizer 2 will automatically adjust the video signal. The video signal contains the three primary color (R.G.B.) signals, a horizontal synchronizing (H-sync) signal and a vertical synchronizing (V-sync) signal. The horizontal synchronizing (H-sync) signal and the vertical synchronizing (V-sync) signal serve to synchronously trigger the three primary color (R.G.B.) signals.

The automatic gain equalizer 2 includes a gain regulator 21 and a processor 22 connected with the gain regulator 21. The gain regulator 21 serves to adjust the amplitude of the video signal. The processor 22 serves to read and analyze the received video signal and judge whether it is necessary to adjust the amplitude of the video signal. The processor 22 includes an analog-to-digital converter 21 (hereinafter abbreviated as ADC). The ADC 221 serves to convert the video signals from analog form into digital form or from digital form into analog form.

In addition, the automatic gain equalizer 2 is connected to a remote-end receiving device 4 via a second transmission cable L2 for transmitting the video signal. The second transmission cable L2 is a VGA transmission cable. The remote-end receiving device 4 can be an LCD display, a projector or a television. Preferably, the remote-end receiving device 4 is, but not limited to, an LCD display. In practice, the remote-end receiving device 4 can be any device capable of displaying the video signal.

The automatic gain equalizer 2 serves to analyze and process the received video signal and judge whether it is necessary to adjust the amplitude of the video signal. If not, the automatic gain equalizer 2 directly transmits the video signal to the remote-end receiving device 4 for the remote-end receiving device 4 to display the video signal. Therefore, the video signal can be automatically adjusted to a standard value. The standard value is a standard value of the amplitude of the video signal (three primary color (R.G.B.) signal), which is 0.7 Vp-p volt.

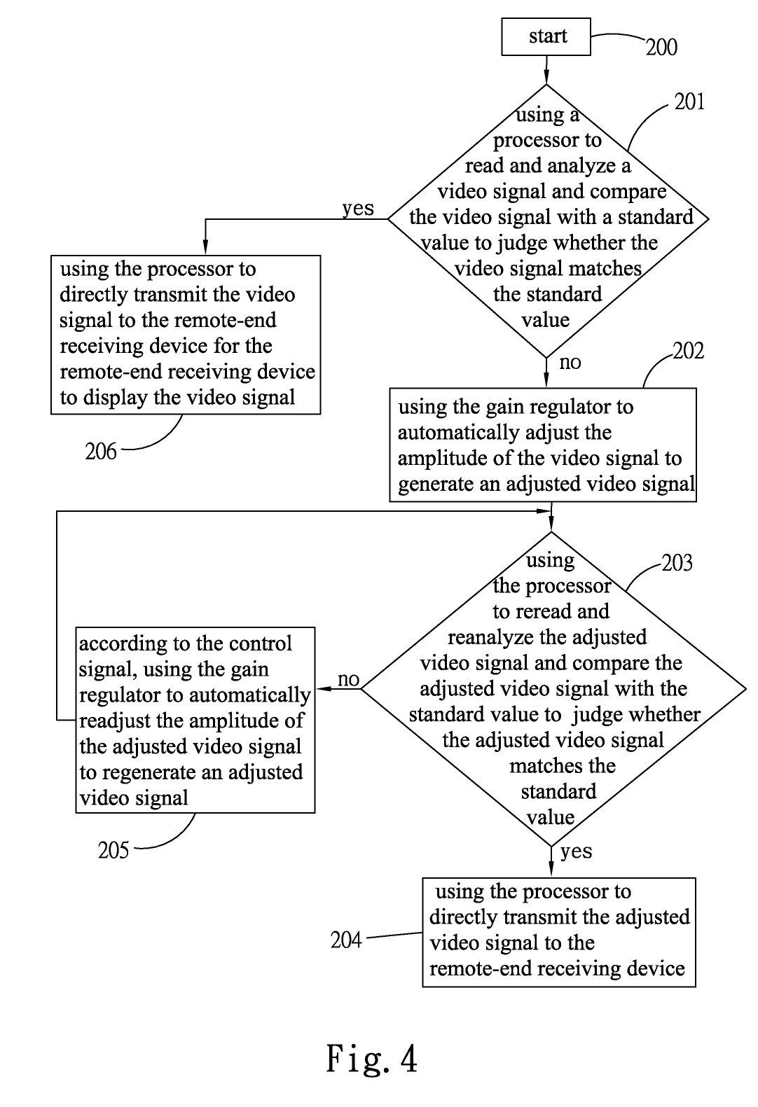

Please refer to FIG. 4, which is a flow chart of the preferred embodiment of the present invention. The automatic video gain adjustment method of the present invention includes:

step 200 of start;

step 201 of using a processor to read and analyze a video signal and compare the video signal with a standard value to judge whether the video signal matches the standard value, if so, the procedure going to step 206, if not, the procedure going to step 202, the electronic device 5 transmitting the video signal to the transmitter 3, the transmitter 3 then transmitting the video signal to the processor 22 of the automatic gain equalizer 2 via the first transmission cable L1 for the processor 22 to read and analyze the video signal and compare the video signal with the standard value, which is 0.7 Vp-p volt, after comparing the three primary color (R.G.B.) signal of the video signal with the standard value, the processor 22 judging whether the three primary color

(R.G.B.) signal of the video signal matches the standard value, if not, the procedure going to step 202, if so, the procedure going to step 206;

step 202 of using the gain regulator to automatically adjust the amplitude of the video signal in case the video signal fails to match the standard value (larger or smaller), the gain regulator then generating an adjusted video signal, in case the three primary color (R.G.B.) signal of the video signal is smaller than the standard value, the processor 22 generating a control signal and transmitting the control signal to the gain regulator 21, according to the control signal, the gain regulator 21 finding that the three primary color (R.G.B.) signal is smaller than the standard value and automatically increasing the amplitude of the three primary color (R.G.B.) signal of the video signal to generate the adjusted video signal, in case the three primary color (R.G.B.) signal of the video signal is larger than the standard value, the processor 22 transmitting the control signal to the gain regulator 21, according to the control signal, the gain regulator 21 finding that the three primary color (R.G.B.) signal is larger than the standard value and automatically decreasing the amplitude of the three primary color (R.G.B.) signal of the video signal to generate the adjusted video signal;

step 203 of using the processor to reread and reanalyze the adjusted video signal and compare the adjusted video signal with the standard value to judge whether the adjusted video signal matches the standard value, if so, the procedure going to step 204, if not, the procedure going to step 205, the processor 22 rereading and reanalyzing the three primary color (R.G.B.) signal of the adjusted video signal and compare the three primary color (R.G.B.) signal with the standard value to judge whether the three primary color (R.G.B.) signal of the adjusted video signal matches the standard value, if so, the procedure going to step 204, if not, the procedure going to step 205;

step 204 of using the processor to directly transmit the adjusted video signal to the remote-end receiving device, in case the processor 22 judges that three primary color (R.G.B.) signal of the adjusted video signal matches the standard value, the processor transmitting the adjusted video signal to the remote-end receiving device 4 via the second transmission cable L2 for the remote-end receiving device 4 to display, whereby the displayed picture is not distorted and the image contrast is saturated;

step 205 of using the processor to generate a control signal and transmit the control signal to the gain regulator, according to the control signal, the gain regulator automatically readjusting the amplitude of the adjusted video signal to regenerate an adjusted video signal and the procedure going back to step 203, the processor 22 repeatedly reading and analyzing the adjusted video signal until the processor 22 finds that the adjusted video signal matches the standard value; and

step 206 of using the processor to directly transmit the video signal to the remote-end receiving device via the second transmission cable for the remote-end receiving device to display the video signal.

According to the aforesaid, by means of the present invention, the video signal can be automatically and more conveniently adjusted to match the standard value. Therefore, the adjustment time is shortened. In conclusion, in comparison with the prior art, the present invention has the following advantages:

1. The video signal can be automatically adjusted to match the standard value.

2. The adjustment process is simplified so that the adjustment time is shortened.

3. The adjustment process can be more conveniently performed.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. An automatic video gain adjustment method in which an automatic gain equalizer is used, the method comprising steps of:
using a processor to read and analyze a video signal and compare the video signal with a standard value to judge whether the video signal matches the standard value;
using a gain regulator to automatically adjust the amplitude of the video signal in case the video signal fails to match the standard value, the gain regulator then generating an adjusted video signal; and
using the processor to transmit the received adjusted video signal to a remote-end receiving device.

2. The automatic video gain adjustment method as claimed in claim 1, wherein if the video signal matches the standard value, the processor directly transmits the video signal to the remote-end receiving device.

3. The automatic video gain adjustment method as claimed in claim 1, wherein if the video signal is smaller than the standard value, the gain regulator automatically increases the amplitude of the video signal to generate the adjusted video signal.

4. The automatic video gain adjustment method as claimed in claim 1, wherein if the video signal is larger than the standard value, the gain regulator automatically decreases the amplitude of the video signal to generate the adjusted video signal.

5. The automatic video gain adjustment method as claimed in claim 1, before the step of using the processor to transmit the received adjusted video signal to the remote-end receiving device, further comprising a step of using the processor to reread and reanalyze the adjusted video signal and compare the adjusted video signal with the standard value to judge whether the adjusted video signal matches the standard value, if so, the processor directly transmitting the adjusted video signal to the remote-end receiving device, if not, the processor generating a control signal and transmitting the control signal to the gain regulator, according to the control signal, the gain regulator automatically readjusting the amplitude of the adjusted video signal to regenerate an adjusted video signal.

6. The automatic video gain adjustment method as claimed in claim 1, wherein the automatic gain equalizer is connected to a transmitter and the transmitter is connected to an electronic device for transmitting the video signal to the automatic gain equalizer.

7. The automatic video gain adjustment method as claimed in claim 6, wherein the transmitter is connected to the automatic gain equalizer via a first transmission cable, the first transmission cable being selected from a group consisting of a CAT5 cable, a CAT5e cable and a CAT6 cable.

8. The automatic video gain adjustment method as claimed in claim 1, wherein the remote-end receiving device is selected from a group consisting of an LCD display, a projector and a television.

9. The automatic video gain adjustment method as claimed in claim 1, wherein the remote-end receiving device is connected to the automatic gain equalizer via a second transmission cable, which is a VGA transmission cable.
